(19) United States
(12) Patent Application Publication
(10) Pub. No.: US 2003/0053882 A1
(43) Pub. Date: Mar. 20, 2003

(54) Repair bolt for a toilet flange

(76) Inventor: Luke N. Reuter, Holiday, FL (US)

Correspondence Address: DAVID W. PETTIS, JR. ESQ., PETTIS & VAN ROYEN, P.A., Suite 700, 501 E. Kennedy Boulevard, Tampa, FL, 33602-5200, US

(21) Appl. No.: 09/954,098

(22) Filed: Sep. 17, 2001

(51) Int. Cl. F16B 39/00

(52) U.S. Cl. 411/107

(57) ABSTRACT

A unitary bolt for repairing cracked or broken flanges to which the base of a toilet is mounted is characterized by its structure comprising a threaded bolt that extends upwardly from, and is fixedly attached to, an arcuate plate. The repair bolt may be inserted under the damaged flange by sliding the plate under the damaged or cracked flange such that the plate will span the damaged portion and the threaded bolt may fit into a notch provided or formed on the flange such that removal and replacement of the flange is not necessary for proper re-seating of the toilet.

### BACKGROUND OF INVENTION

1. Field of the Invention

The present invention relates to a repair bolt structure whereby one may easily repair a damaged toilet flange without the necessity of removing and replacing the damaged flange.

2. Description of the Prior Art

According to typical and well-known construction and installation techniques, a standard toilet bowl is attached to the waste drain by bolting the bowl to a floor flange which is mounted at the top of the drain, substantially level with floor. Prior to approximately 1975, most such toilet flanges were made of cast iron or copper. Since 1975, the use of plastic toilet flanges has become quite common. Frequently, and for a variety of a reasons, the toilet flange tends to break or crack over time. Such damage may be the result of not having positioned the flange properly during the original installation because of having to contend with a floor surface that is not level, or could even be the result of improper use of the toilet by standing on it for some use totally unrelated to the toilet's intended use, such as, for example, hanging a shower curtain or simply cleaning the bathroom.

Whatever the reason for damage to the toilet flange, the result is that one must remove the toilet and replace or repair the flange. Obviously, this is both a time consuming and expensive procedure.

Professionals in the plumbing industry have recognized the desirability of being able to repair the damaged flange without the necessity of having to remove the damaged flange and replace it with a new one. In fact, prior art patents provide both suggested devices and methods for accomplishing such repairs. One example is found in U.S. Pat. No. 4,207,630, which discloses the use of a spanner which has a slot formed therethrough and is intended to be placed under the damaged flange to “span” the cracked or broken portion. A relatively standard mounting bolt is then inserted, from the bottom, through the slot in the spanner and through a corresponding slot formed in the typical toilet flange. However, it is immediately apparent that in order to insert the bolt, the toilet flange must be completely removed and then reassembled to the drain.

Other forms of repair flanges are disclosed in U.S. Pat. Nos. 4,886,302; 5,246,255; and 5,335,849. Of course, these prior art patents are identified as being examples, only, for other such devices are known in the prior art. However, examination and use of existing prior art devices confirm that removal of the damaged flange so that a bolt can be inserted through both the repair device and the damaged flange for remounting of the toilet is necessary.

It is therefore clear that there remains in the art a need for a device which would permit repairing/reinforcing a damaged or broken toilet flange without the necessity of total removal of the flange in order to accomplish the repair and re-seat the toilet bowl.

### SUMMARY OF THE INVENTION

The present invention relates to a repair bolt used to fix a damaged toilet flange and its structure permits the repair without the necessity of having to remove the damaged flange completely. The repair bolt of this invention comprises an arcuate plate having a threaded bolt fixed thereto and extending upwardly in substantially normal relation to a top surface of the plate. According to a preferred embodiment, discussed in greater detail hereinafter, the arcuate plate further comprises a pair of auxiliary apertures, one aperture being formed through the plate in spaced apart relation to each of the opposed distal ends of the plate.

In use, the plate is slid under the damaged flange such that the plate spans the damaged portion. The threaded bolt extending upwardly therefrom is received either by an existing slot in the toilet flange, or by a slot formed or cut into the flange. Thus, the repair bolt of this invention may be placed under the damaged flange without the necessity of entirely disassembling and removing the flange from the drain pipe. The auxiliary apertures may be used for the reception of screws inserted from the exposed upper surface of the damaged flange in order to reinforce attachment of the repair bolt to the toilet flange, if deemed necessary by the user. The upstanding threaded bolt is, of course, used to reattach the toilet bowl to the repaired flange according to standard installation procedures.

The invention accordingly comprises an article of manufacture possessing the features, properties, and the relation of elements which will be exemplified in the article hereinafter described, and the scope of the invention will be indicated in the claims.

### BRIEF DESCRIPTION OF THE DRAWINGS

For a fuller understanding of the nature and objects of the invention, reference should be had to the following detailed description taken in connection with the accompanying drawings, in which:

FIG. 1 is a side elevation showing the placement of a pair of the repair bolts of this invention on a toilet flange, the flange being shown in phantom.

FIG. 2 is a bottom plan view of the pair of repair bolts as shown in the view FIG. 1.

FIG. 3 is an end view of the repair bolt of this invention.

FIG. 4 is a front view of the repair bolt.

FIG. 5 is a bottom view of the repair bolt.

FIG. 6 is a perspective view of the repair bolt.

Similar reference characters refer to similar parts throughout the several views of the drawings.

### DETAILED DESCRIPTION OF THE INVENTION

As perhaps best seen in the view of FIG. 6, the preferred embodiment of the repair bolt of this invention is generally indicated as 10. Repair bolt 10 comprises an arcuate plate generally indicated as 12 and having a top surface 14, a bottom surface 16, a first end 18, and a second end 20. Repair bolt 10 further comprises a threaded bolt generally indicated as 22. Threaded bolt 22 is fixedly attached to arcuate plate 12 at first bolt end 24 and extends upwardly from top surface 14, terminating in distal bolt end 26.

It is to be understood that threaded bolt 22 may be fixed to arcuate plate 12 by any suitable means, and the scope of invention is not to be limited by the particular attachment chosen. However, as can be seen by referring to the bottom view of FIG. 5, attachment is preferably accomplished by inserting first bolt end 24 through a threaded bolt aperture 28 formed through arcuate plate 12 and attaching first bolt end 24 as by, for example, welding or brazing.

Still referring to the views of FIGS. 5 and 6, the preferred embodiment of repair bolt 10 further comprises a first auxiliary aperture 30 formed through arcuate plate 12 in spaced apart relation to first end 18 and a corresponding second auxiliary aperture 32 formed through arcuate plate 12 in spaced apart relation to second end 20.

For purposes of a full and complete disclosure of this preferred embodiment for repair bolt 10, but without any intention of limiting the scope of the invention, arcuate plate 12 is preferably formed from sheet metal, and threaded bolt 22 is preferably defined by a 5/16 inch brass rod extending upwardly from top surface 14 approximately 2 ½ inches. One can also see that threaded bolt 22 is substantially normal to top surface 14 and is fixed to arcuate plate 12 at the substantial midpoint thereof, the midpoint being defined by a plane that is normal to top surface 14 and equidistant from first end 18 and second end 20. First auxiliary aperture 30 and second auxiliary aperture 32 preferably have a diameter of about ¼ inch and are each spaced approximately ⅝ inches from first end 18 and second end 20, respectively.

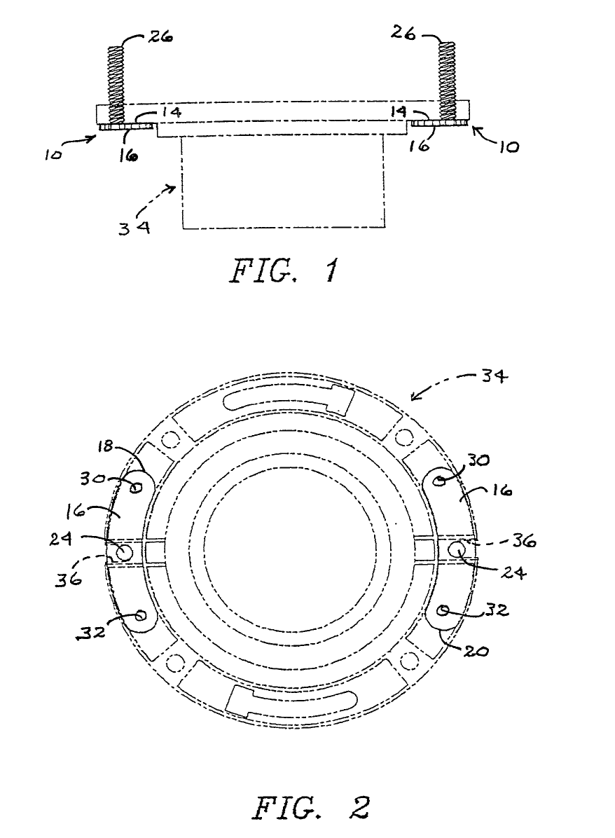

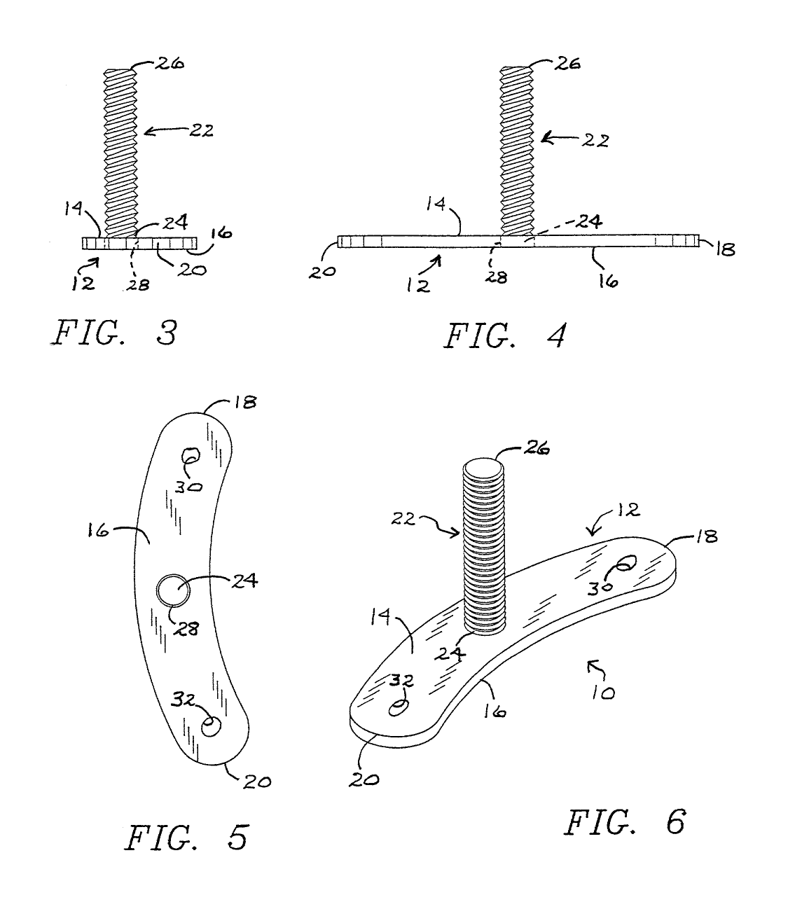

Having thus set forth a preferred structure for repair bolt 10, attention is now invited to the views of FIGS. 1 and 2.

FIG. 1 presents a side elevation of a typical toilet flange, which is shown in phantom and generally indicated as 34. A pair of repair bolts 10 are shown on toilet flange 34 as they might be operatively installed. The view of FIG. 2 is a bottom plan view of the typical installation shown in FIG. 1. It is of course to be understood that FIGS. 1 and 2 illustrate the use of a pair of repair bolts 10 only for purposes of illustration. It is also to be understood that in a use calling for more than one of the repair bolts 10, it is not necessary that they be position 180 degrees from each other. Rather, they would be positioned so that arcuate plate 12 would span the broken portion of toilet flange 34. As previously indicated, toilet flange 34 is typically formed from either cast iron, copper, or plastic. Also, as is seen in the view of FIG. 2, typical toilet flange 34 includes a variety of apertures and slots formed around its outer lip and used for attaching the toilet thereto. It is because the toilet is attached to toilet flange 34 through the outer, relatively thinner, perimeter lip of toilet flange 34 that one frequently encounters cracks or breaks, requiring repair to prevent leakage.

With regard to the view of FIG. 2, one can also see that a typical toilet flange 34 may include one or more notches 36 that are of substantial U-shaped configuration with the open end of the “U” defining an opening around the outer most perimeter of toilet flange 34. For purposes of illustration, the views of FIGS. 1 and 2 show placement of each repair bolt 10 within a corresponding one of the notches 36. However, if repair bolt 10 needed to be placed at a location around the perimeter of toilet flange 34 that would not permit insertion into a notch 36, the person making the repair would simply use an appropriate cutting tool to create such a notch for the purpose of inserting a repair bolt 10 under toilet flange 34 so that arcuate plate 12 would span the damaged portion of the toilet flange 34. Though not shown in the view of FIG. 2, it is to be remembered that first auxiliary aperture 30 and/or second auxiliary aperture 32 may be used to receive an auxiliary fastener (also not shown) in order to enhance the repair effect of repair bolt 10 by the use of an auxiliary fastener inserted through toilet flange 34 into engagement with a corresponding one of the auxiliary apertures 30 or 32.

Having placed a repair bolt 10 underneath the damaged toilet flange 34 such that arcuate plate 12 spans the damaged portion of the toilet flange 34, the repair person may then proceed to reinstall the toilet according to standard installation procedures. Thus, by virtue of the unique construction of repair bolt 10 so that it is not necessary to insert a bolt from the bottom of arcuate plate 12, because threaded bolt 22 is fixedly attached thereto, the repair bolt 10 may simply be placed under the damaged portion of toilet flange 34 without the necessity of removing toilet flange 34 as is currently required utilizing state-of the-art repair devices.

It will thus be seen that the objects set forth above, among those made apparent from the preceding description, are efficiently attained, and since certain changes may be made in the above article without departing from the scope of the invention, it is intended that all matter contained in the above description or shown in the accompanying drawings shall be interpreted as lustrative and not in a limited sense.

It is also to be understood that the following claims are intended to cover all of the generic and specific features of the invention herein described, and all statements of the scope of the invention which, as a matter of language, might be said to fall there between.

Now that the invention has been described,

What Is claimed Is:

1. A repair bolt for a toilet flange, said repair bolt comprising: an arcuate plate having a top surface, a bottom surface, a first end, and a second end; a threaded bolt fixed to said arcuate plate and extending upwardly from said top surface, said threaded bolt comprising a first bolt end attached to said arcuate plate and a distal bolt end spaced apart from said top surface; a first auxiliary aperture formed through said top surface and said bottom surface of said arcuate plate in spaced apart relation to said first end; and a second auxiliary aperture formed through said top surface and said bottom surface of said arcuate plate in spaced apart relation to said second end.

2. A repair bolt for a toilet flange, said repair bolt comprising: an arcuate plate having a top surface, a bottom surface, a first end, a second end, and a midpoint defined by a plane that is normal to said top surface and equidistant from said first and second ends; and a threaded bolt fixed to said arcuate plate substantially at said midpoint of said top surface and extending upwardly from said top surface, said threaded bolt comprising a first bolt end attached to said arcuate plate and a distal bolt end spaced apart from said top surface.

3. A repair bolt for a toilet flange, said repair bolt comprising: an arcuate plate having a top surface, a bottom surface, a first end, a second end, and a midpoint defined by a plane that is normal to said top surface and equidistant from said first and second ends; a threaded bolt fixed to said arcuate plate substantially at said midpoint of said top surface and extending upwardly from said top surface, said threaded bolt comprising a first bolt end attached to said arcuate plate and a distal bolt end spaced apart from said top surface; a first auxiliary aperture formed through said top surface and said bottom surface of said arcuate plate in spaced apart relation to said first end; and a second auxiliary aperture formed through said top surface and said bottom surface of said arcuate plate in spaced apart relation to said second end.
